(19) United States
(12) Patent Application Publication
(10) Pub. No.: US 2010/0288136 A1
(43) Pub. Date: Nov. 18, 2010

(54) REINFORCED BAKING TRAY

(75) Inventor: Jason Tingley, Enon, OH (US)

Correspondence Address: MCNEES WALLACE & NURICK LLC, 100 PINE STREET, P.O. BOX 1166, HARRISBURG, PA, 17108-1166, US

(73) Assignee: American Pan Company, Urbana, OH (US)

(21) Appl. No.: 12/466,547

(22) Filed: May 15, 2009

(51) Int. Cl. A21B 3/13; B21D 11/10

(52) U.S. Cl. 99/324; 72/379.4

(57) ABSTRACT

A baking article is provided that includes a substantially rectangular baking surface; a walled portion surrounding the baking surface, wherein the topmost region of the walled portion surrounding the baking surface is rolled downward and away from the baking surface to form a lip and define the outer edge of the tray; and a plurality of indentations formed in the walled portion surrounding the baking surface, wherein the plurality of indentations provides structural reinforcement to the baking tray.

### BACKGROUND OF THE INVENTION

The present invention relates generally to pans or trays used in the production and preparation of baked goods or other food, and specifically to a structurally reinforced baking tray for use in high-volume industrial baking applications.

Baking pans or trays are commonly used by producers of various baked goods that are supplied to restaurants and grocery stores. Because producers of baked goods often supply large quantities of baked goods to their customers, the trays on which these goods are baked are typically reused many times and are repeatedly subjected to both high thermal and mechanical stresses. Baking pans are often stacked on top of one another, and it common for a stack of baking pans to include more than fifty pans. Stacking pans in this manner creates significant pressure on the bottom pan in a stack, and the weight on the bottom pan may be as much as 500 pounds. Thus, repeated use and repeated exposure to high temperatures and mechanical stress requires that an industrial baking tray be manufactured from a durable material such as steel or aluminum.

Although manufacturing a baking tray from materials such as steel or aluminum does increase the lifespan of the tray, additional features may be included to lend strength and stability, particularly when the tray is large in size. One approach to adding strength and durability has been the inclusion of support ribs on the interior portion of the pan between indentations or depressions where dough is placed prior to baking. Such ribs may partially run across the length of pan, across the width of a pan, or both. While somewhat effective at increasing the overall strength of the pan, these support ribs do not prevent warping and may actually create stress points at the intersections of the ribs. Repeated use, re-glazing, or other physical or chemical stressors eventually weakens the metal of the tray and cracks or fractures may appear in the metal surface of the tray. Once a tray has sustained such damage, it is no longer useable and must be discarded. Due to the expense of replacing industrial baking trays, there is a need for a baking tray that includes features that provide strength and stability, but that reduce the potential for damage caused by fractures in the metal of the tray.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a baking article is provided. This baking article includes a baking surface; a walled portion surrounding the baking surface, wherein the topmost region of the walled portion surrounding the baking surface is rolled downward and away from the baking surface to form a lip and define the outer edge of the tray; and a plurality of indentations formed in the walled portion surrounding the baking surface, wherein the plurality of indentations provides structural reinforcement to the baking tray.

In accordance with another aspect of the present invention, a baking is provided. This baking tray includes a substantially rectangular baking surface; a walled portion surrounding the baking surface; a band of material surrounding the walled portion of the baking surface, wherein the topmost region of the walled portion surrounding the baking surface is rolled downward and away from the baking surface to enclose the band of material and define the outer edge of the tray; and a plurality of indentations formed at regular and continuous intervals in the walled portion surrounding the baking surface for providing structural reinforcement to the baking tray.

In yet another aspect of this invention, a method for making a baking tray is provided. This method for making a baking tray providing a substantially rectangular, flat piece of material for use as a baking surface; bending the edges of the piece of material upward to form walled portion surrounding the baking surface; and forming a plurality of indentations in the walled portion surrounding the baking surface; wherein the plurality of indentations provides structural reinforcement to the baking tray.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1A is a top view of a first exemplary embodiment of the present invention wherein a plurality of indentations has been formed in the walls of the baking article;

FIG. 1B is a side view of the baking article of FIG. 1A, further illustrating the placement of the indentations in the walled portion of the baking article as well as the position of the band of material surrounding the walled portion;

FIG. 1C is a perspective view of the baking article of FIG. 1A; and

FIG. 2 is a perspective view of a second exemplary embodiment of the baking article of the present invention, wherein a plurality of lengthwise and widthwise support ribs have been formed in the baking surface for providing additional structural support to the baking article.

### DETAILED DESCRIPTION OF THE INVENTION

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates generally to baking hardware, and more specifically to an industrial or commercial baking pan or tray that includes certain reinforcing features formed in the material of the pan itself for preventing warping and other stress-related damaged. Exemplary embodiments of this invention provide structurally reinforced, durable baking trays or pans for use in high-volume industrial baking applications. The baking trays of the present invention include a substantially flat baking surface that is surrounded on all sides by walls typically formed of the same material as the baking surface. An optional separate band of material may be placed around the top portion (i.e., perimeter) of these walls and then the metal of the baking tray (i.e., baking surface) may be wrapped downward and around this separate band of material to form a substantially continuous metal surface. Fabricating the outer edge of the tray in this manner imparts significant structural strength and stability to the baking tray. In a first exemplary embodiment, a plurality of scallop-like (e.g., gussets, flutes) indentations have been formed in the metal walls surrounding the baking surface for providing additional support and stability to the baking tray. In a second exemplary embodiment, in addition to the scallop-like indentations, a plurality of lengthwise and widthwise supportive ridges has been formed in the baking surface. The combination of the band of material encircling the baking surface, scallop-like indentations, and lengthwise and widthwise support ribs that intersect with one another results in a baking tray that is structurally very strong, and consequently, very durable. With reference now to the Figures, one or more specific embodiments of this invention shall be described in greater detail.

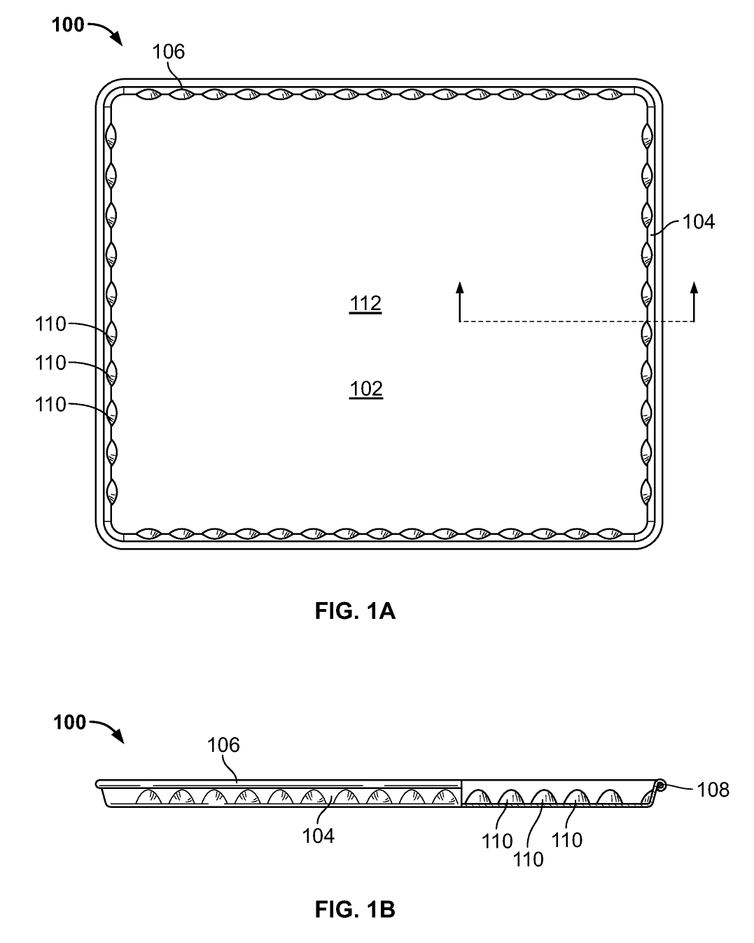

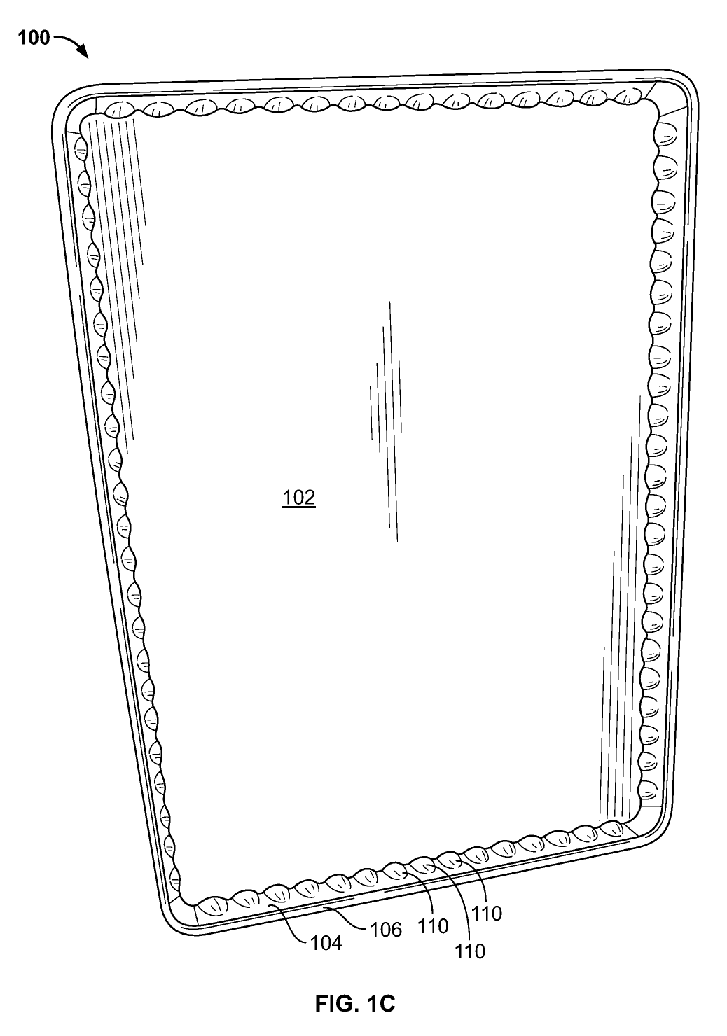

As shown in FIGS. 1A-C, baking tray 100 includes a substantially rectangular and flat baking surface 102, surrounded by walled portion 104, which is typically formed from the same material as baking surface 102. Walled portion 104 typically extends upward and away from baking surface 102 at a slight outward angle to increase the stackability of baking tray 100. During manufacturing (i.e., fabrication), the outermost edge of walled portion 104 is rolled downward and away from baking surface 102 to form a smooth lip 106, which surrounds baking tray 100. In some embodiments, a band 108 of reinforcing material is placed around the outer perimeter of walled portion 104 prior to the creation of lip 106. Perimeter band 108 may be fabricated from carbonized steel, aluminum, stainless steel, or any other suitable metal. The dimensions of the perimeter band may vary depending on the overall dimensions and physical characteristics of a particular type of tray. As best shown in FIGS. 1A and 1C, baking tray 100 further includes a plurality of indentations 110, which may also be described as scallops, gussets, or flutes formed in walled portion 104. Indentations 110 may be formed intermittently or continuously at regular intervals around the entire perimeter of baking surface 102 for providing additional structural support to baking tray 100 and for preventing or at least minimizing any tendency of the tray to flex or bow during normal use. These indentations may be formed in a variety of different geometric configurations are not necessarily limited to the shapes shown in the Figures. In some embodiments, baking surface 102 further includes an upwardly-arched region or convex surface 112 formed therein, for providing additional structural reinforcement to baking surface 102. The center of convex surface typically rises about 3/16 of an inch (about 0.5 cm) from the bottom perimeter of baking surface 102. This convex region imparts residual stress to baking surface 102 and the slight upward arch counters the common failure of sheet pans bowing downward with use and thus becoming undesirably concaved.

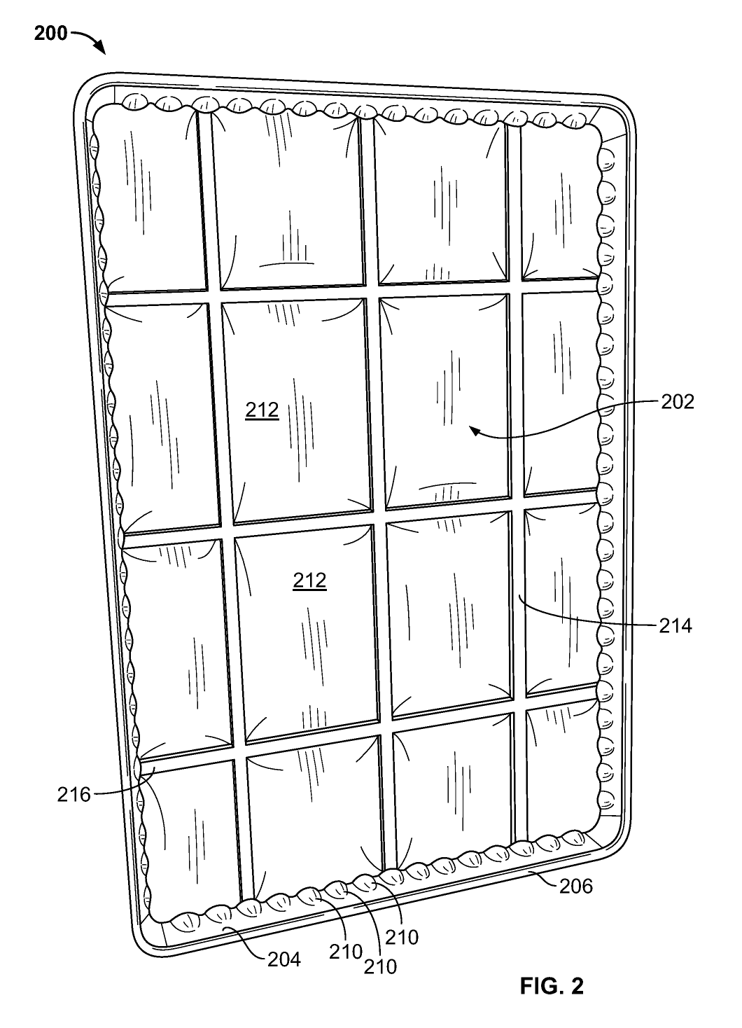

As shown in FIG. 2, baking tray 200 includes a substantially rectangular and flat baking surface 202, surrounded by walled portion 204, which is typically formed from the same material as baking surface 202. Walled portion 204 typically extends upward and away from baking surface 202 at a slight outward angle to increase the stackability of baking tray 200. During manufacturing (i.e., fabrication), the outermost edge of walled portion 204 is rolled downward and away from baking surface 202 to form a smooth lip 206, which surrounds baking tray 200. In some embodiments, a band (not shown) of reinforcing material is placed around the outer perimeter of walled portion 204 prior to the creation of lip 206. Perimeter band 208 may be fabricated from carbonized steel, aluminum, stainless steel, or any other suitable metal. The dimensions of the perimeter band may vary depending on the overall dimensions and physical characteristics of a particular type of tray. As shown in FIG. 2, baking tray 200 further includes a plurality of indentations 210, which may also be described as scallops, gussets, or flutes formed in walled portion 204. Indentations 210 may be formed intermittently or continuously at regular intervals around the entire perimeter of baking surface 202 for providing structural support to baking tray 200 and preventing or at least minimizing any tendency of the tray to flex or bow during normal use. These indentations may be formed in a variety of different geometric configurations. Also as shown in FIG. 2, at least one lengthwise support rib 214 and at least one widthwise support rib 216 are formed in baking surface 202. These support ribs are formed from the same material as baking surface 202 and run through and across baking surface 202 such that the support ribs intersect one another at various points on baking tray 200. These ribs may be raised to form individual baking subunits or may be recessed to create a substantially flat baking surface. In some embodiments, baking surface 202 further includes upwardly-arched regions or convex surfaces 212 formed between support ribs 214 and 216, for providing additional structural reinforcement to baking surface 202.

The combination of the perimeter band, gussets, and optional support ribs form a structural support system that makes this baking tray appreciably stronger and more durable than currently available industrial baking trays. The design of the tray minimizes physical stresses occurring across the surface of the tray and significantly reduces the likelihood of cracks or fractures. Furthermore, the perimeter band, gussets, and optional support ribs design effectively reinforces the sheet metal of the baking surface, thereby reducing the tendency of the baking tray to warp (i.e., minimizes bowing of the bottom of the pan and outward flexing of the sides of the pan) as the result of repeated exposure to thermal stresses.

The baking tray of the present invention may be manufactured from tin-plated steel, aluminized steel, carbonized steel, stainless steel, titanium, or any other suitable metal and may be formed by the known process of “drawing.” The process of drawing involves forming the pan from a single sheet of material. Through a series of forming operation, the material is deformed or “drawn” to shape and define the various features at predetermined locations on the sheet. If so desired by the user of the baking tray, the tray may be covered or coated with certain materials, such as, for example, glazing material or other coating materials common to the baking industry

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A baking article, comprising:
(a) a baking surface;
(b) a walled portion surrounding the baking surface, wherein the topmost region of the walled portion surrounding the baking surface is rolled downward and away from the baking surface to form a lip and define the outer edge of the tray; and
(c) a plurality of indentations formed in the walled portion surrounding the baking surface, wherein the plurality of indentations provides structural reinforcement to the baking tray.

2. The baking article of claim 1, further comprising a band of material surrounding the walled portion of the baking surface, wherein the topmost region of the walled portion surrounding the baking surface is rolled downward and away from the baking surface to enclose the band of material.

3. The baking article of claim 2, wherein the band of material is manufactured from carbonized steel, aluminum, stainless steel, or combinations thereof.

4. The baking article of claim 1, wherein the substantially rectangular baking surface further comprises an upwardly-arched region formed therein, and wherein the upwardly arched region provides structural reinforcement to the baking surface.

5. The baking article of claim 1, wherein the substantially rectangular baking surface further comprises:
(a) at least one lengthwise support rib formed therein; and
(b) at least one widthwise support rib formed therein and running through the baking surface such that the widthwise support rib intersects the lengthwise support rib.

6. The baking article of claim 1, wherein the plurality of indentations are formed at regular intervals in the walled portion surrounding the baking surface.

7. The baking article of claim 1, wherein the plurality of indentations are formed at irregular intervals in the walled portion surrounding the baking surface.

8. The baking article of claim 1, wherein the baking article is manufactured from tin-plated steel, aluminized steel, carbonized steel, stainless steel, titanium, or combinations thereof.

9. A baking tray, comprising:
(a) a baking surface;
(b) a walled portion surrounding the baking surface;
(c) a band of material surrounding the walled portion of the baking surface, wherein the topmost region of the walled portion surrounding the baking surface is rolled downward and away from the baking surface to enclose the band of material and define the outer edge of the tray; and
(d) a plurality of indentations formed at regular and continuous intervals in the walled portion surrounding the baking surface for providing structural reinforcement to the baking tray.

10. The baking article of claim 2, wherein the band of material is manufactured from carbonized steel, aluminum, stainless steel, or combinations thereof.

11. The baking article of claim 1, wherein the substantially rectangular baking surface further comprises an upwardly-arched region formed therein, and wherein the upwardly arched region provides structural reinforcement to the baking surface.

12. The baking article of claim 1, wherein the substantially rectangular baking surface further comprises:
(a) at least one lengthwise support rib formed therein; and
(b) at least one widthwise support rib formed therein and running through the baking surface such that the widthwise support rib intersects the lengthwise support rib.

13. The baking article of claim 1, wherein the plurality of indentations are formed at regular intervals in the walled portion surrounding the baking surface.

14. The baking article of claim 1, wherein the plurality of indentations are formed at irregular intervals in the walled portion surrounding the baking surface.

15. The baking article of claim 1, wherein the baking article is manufactured from tin-plated steel, aluminized steel, carbonized steel, stainless steel, titanium, or combinations thereof.

16. A method for making a baking tray, comprising:
(a) providing a substantially rectangular, flat piece of material for use as a baking surface;
(b) bending the edges of the piece of material upward to form walled portion surrounding the baking surface; and
(c) forming a plurality of indentations in the walled portion surrounding the baking surface; wherein the plurality of indentations provides structural reinforcement to the baking tray.

17. The method of claim 16, further comprising wrapping a band of material around the walled portion surrounding the baking surface, and rolling the topmost region of the walled portion downward and away from the baking surface to enclose the band of material therein.

18. The method of claim 16, further comprising forming an upwardly-arched region in the baking surface, wherein the upwardly arched region provides structural reinforcement to the baking surface.

19. The method of claim 16, further comprising forming at least one lengthwise support rib in the baking surface; and forming at least one widthwise support rib in the baking surface, wherein the at least one widthwise support rib intersects the at least one lengthwise support rib.

20. The method of claim 16, wherein the substantially rectangular, flat piece of material and the band of material are manufactured from tin-plated steel, aluminized steel, carbonized steel, stainless steel, titanium, or combinations thereof.
